(19) United States
(12) Patent Application Publication
(10) Pub. No.: US 2013/0145475 A1
(43) Pub. Date: Jun. 6, 2013

(54) METHOD AND APPARATUS FOR SECURING TOUCH INPUT

(71) Applicant: Samsung Electronics Co., Ltd., Gyeonggi-do (KR)

(72) Inventors: Jaemin RYU, Gyeonggi-do (KR); Kyungsoo Kwag, Gyeonggi-do (KR); Jungkyuen Lee, Gangwon-do (KR); Kyungim Jung, Gyeonggi-do (KR); Hyunjin Choi, Seoul (KR)

(73) Assignee: Samsung Electronics Co., Ltd., Gyeonggi-do (KR)

(21) Appl. No.: 13/690,573

(22) Filed: Nov. 30, 2012

Related U.S. Application Data
(60) Provisional application No. 61/566,113, filed on Dec. 2, 2011.

(30) Foreign Application Priority Data
Feb. 7, 2012 (KR) 10-2012-0012306

(51) Int. Cl. G06F 17/30

(52) U.S. Cl. 726/26

(57) ABSTRACT

A method and apparatus for securing touch input are provided. The method includes rendering a first screen in a secure world; rendering a second screen in a non-secure world; and outputting a secured input screen by displaying the first screen as an overlay above the second screen.

### PRIORITY

This application claims priority under 35 U.S.C. §119(e) to a U.S. Provisional application filed on Dec. 2, 2011 in the U.S. Patent and Trademark Office and assigned Ser. No. 61/566,113, and under 35 U.S.C. §119(a) of a Korean patent application filed on Feb. 7, 2012 in the Korean Intellectual Property Office and assigned Serial No. 10-2012-0012306, the entire content of each of which is incorporated herein by reference.

### BACKGROUND OF THE INVENTION

1. Field of the Invention

The present invention relates generally to a method and apparatus for securing touch input and, more particularly, to a method and apparatus that ensure security of information input through a touch panel.

2. Description of the Related Art

With advances in communication technologies, electronic devices having wireless communication units may send and receive various types of information to and from many web servers on the Internet. In particular, for many reasons, online shopping over the Internet has become a common part of life. To buy a product through online shopping, a buyer using an electronic device may be required to perform an electronic payment procedure. For electronic payment, the buyer may send a Personal Identification Number (PIN) code corresponding to a credit card or a bank account to the corresponding web server. In recent years, as increasing numbers of electronic devices include touch panels enabling easy input, users increasingly enter PIN codes through touch panels. An electronic device performing an electronic payment procedure may display a virtual keypad for entering a PIN code on the touch panel.

Theft of PIN codes to other persons may cause severe financial damage to users or buyers. Unfortunately, as electronic payment systems have become popular, the number of hacking attempts for PIN codes has also increased.

Currently, a PIN code hacking program running on an electronic device may deduce a PIN code from the layout of touched numeric keys of a keypad displayed on the touch panel, touch signals generated by the touch panel, or a combination thereof.

In order to prevent such hacking, there is a need for a way to ensure security with respect to inputting a PIN code through a touch panel.

### SUMMARY OF THE INVENTION

The present invention has been made to address at least the above-described problems and provide at least the advantages described below. Accordingly, the present invention provides a security method and apparatus that prevent leakage of information input through a touch panel.

In accordance with an embodiment of the present invention, an apparatus for securing touch input is provided. The apparatus includes a secure overlay frame buffer for rendering a first screen; a non-secure overlay frame buffer for rendering a second screen; a display unit for outputting a secured input screen; and a control unit for controlling the display unit to display the first screen as an overlay above the second screen so as to produce the secured input screen.

In accordance with another embodiment of the present invention a method for securing touch input is provided. The method includes rendering a first screen in a secure world; rendering a second screen in a non-secure world; and outputting a secured input screen by displaying the first screen as an overlay above the second screen.

In accordance with another aspect of the present invention, an apparatus for securing touch input is provided. The apparatus includes a touchscreen having a touch panel and a display unit; a secure storage for storing a Personal Identification Number (PIN) code input security module; a non-secure storage for storing a PIN User Interface (UI) program and an agent; and a control unit controlling the touchscreen, secure storage, and non-secure storage, wherein the PIN UI program sends a secure Input/Output (I/O) request to the agent in response to user input, the agent initiates the PIN code input security module in response to the secure I/O request, and the PIN code input security module sets a security attribute of the touch panel as secured, directs a secure overlay frame buffer to render a keypad screen, receives touch input from the touch panel whose security attribute is set as secured, and forwards the received touch input to the PIN UI program or a touch input processing device.

### BRIEF DESCRIPTION OF THE DRAWINGS

The features and advantages of the present invention will be more apparent from the following detailed description in conjunction with the accompanying drawings, in which:

FIG. 1 is a diagram illustrating a mobile terminal for ensuring security according to an embodiment of the present invention;

FIG. 2A is a block diagram illustrating a hardware architecture for ensuring security in a device according to an embodiment of the present invention;

FIG. 2B is a block diagram illustrating a mobile terminal according to an embodiment of the present invention;

FIG. 3 is a flowchart illustrating a procedure for secured input through a touch panel according to another embodiment of the present invention;

FIG. 4A is a diagram illustrating a software architecture supporting the procedure of FIG. 3 according to an embodiment of the present invention;

FIG. 4B is a diagram illustrating another software architecture supporting the procedure of FIG. 3 according to an embodiment of the present invention;

FIG. 5 is a diagram illustrating a touch input screen according to an embodiment of the present invention; and

FIG. 6 is a diagram illustrating another touch input screen according to an embodiment of the present invention.

### DETAILED DESCRIPTION OF EMBODIMENTS OF THE PRESENT INVENTION

Hereinafter, embodiments of the present invention are described in detail with reference to the accompanying drawings. The same reference symbols may be used throughout the drawings to refer to the same or like parts. Detailed descriptions of well-known functions and structures incorporated herein may be omitted to avoid obscuring the subject matter of the present invention.

A secure world and a normal (non-secure) world according to embodiments of the present invention are described as follows.

Embodiments of the present invention utilize computing resources. A person having ordinary skill in the art will appreciate that computing resources encompass a wide variety of entities. For example, computing resources may include (i) hardware in the form of, for example, processors, Application Specific Integrated Circuit (ASIC) modules, memory/storage units, peripheral devices, interrupt lines, signal paths, data/address/control buses, and the like; (ii) software and/or firmware in the form of, for example operating systems, application programs, and the like; and (iii) other resources such as stored data and/or files.

In the description and claims of the present specification, a “world” refers to a certain operating environment/mode/state/domain involving a certain set of computing resources. Furthermore, a “secure world” and a “non-secure world” refer to respective operating domains differing in the level of protection given to computing resources implementing those operating domains. Here, “protection” means protection from hacking (for example in the form of unauthorized access and/or modification and/or manipulation of the computing resources) by one or more security features.

For example, a “secure world” may refer to an operating domain involving certain computing resources having a first level of protection (e.g. at least some of the computing resources are protected by one or more security features). Meanwhile, a “non-secure world” may refer to an operating domain involving certain computing resources having a second level of protection (e.g. fewer or none of the computing resources are protected by security features), where the first level of protection is higher than the second level of protection.

A person having ordinary skill in the art will appreciate that there are numerous security features that may be used to protect computing resources from hacking, for example in the form of unauthorized access and/or modification and/or manipulation of the computing resources. For example, security features may include: encryption, authentication and/or verification schemes; mechanisms for isolating (physically and/or logically) components using hardware and/or software; storage of software and/or firmware and/or data and/or files in regions of protected memory or un-modifiable memory (such as a Read Only Memory (ROM) or one-time programmable memory); execution of processors and other components in a secure mode; masking of interrupt lines and other inter-component signaling; and the like.

A person having ordinary skill in the art will appreciate that different computing resources may be used in a secure world and a non-secure world, and that a specific computing resource may be used in both the secure world and the insecure world, for example by switching between a secure mode and an insecure mode, or by partitioning a specific computing resource (e.g. memory or processor resource) into secure and non-secure parts. A person having ordinary skill in the art will also appreciate that an overall system may include both a secure world and an insecure world at the same time.

In the secure world (similar to a secure state or a secure domain), secure application programs are executed on top of a secure operating system. Secure application programs access secure data. Secure application programs are stored in a secure storage unit isolated by hardware and software mechanisms. As the capacity of the secure storage unit is limited by system design, a secure application program is designed to have a small size, so that it can support only essential functions. Secure data includes information stored in the secure world and secured signals generated by peripheral devices.

In the non-secure (normal) world, a non-secure operating system and non-secure application programs are provided. The non-secure operating system is a regular operating system supporting overall operations of a mobile terminal or other device, and a non-secure application program is an ordinary application program. A non-secure application program running in the non-secure world is prevented from accessing secure data. In particular, when a hacking program is executed in the non-secure world, the hacking program cannot access secure data or a process working in the secure world. According to embodiments of the present invention, as touch input is processed in the secure world, a high level of security is ensured.

The secure world and the non-secure world are supported by a secure processing architecture based on TrustZone Technology of ARM Holdings, but other technologies may be used in accordance with embodiments of the present invention. According to embodiments of the present invention, security utilizing both the secure world and the non-secure world are provided.

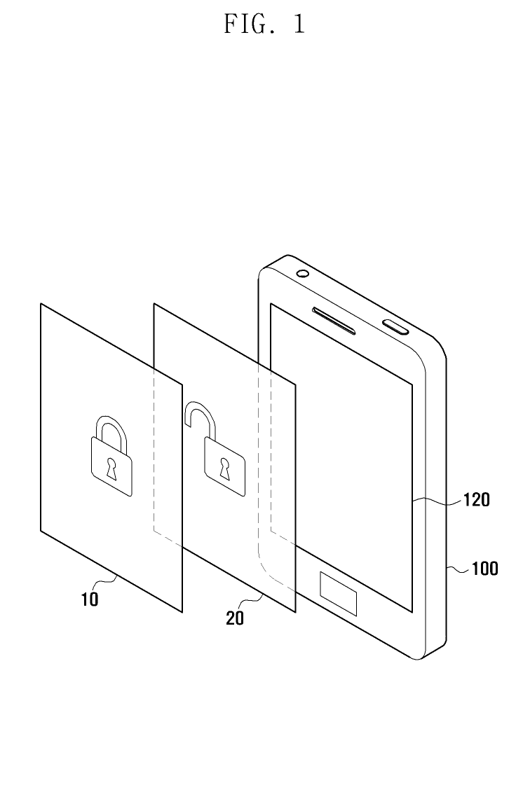

An overview of the present invention is provided with reference to FIG. 1. FIG. 1 is a diagram illustrating a mobile terminal for ensuring security according to an embodiment of the present invention.

Referring to FIG. 1, an embodiment of the present invention includes a mobile terminal 100 having a touchscreen 120, which includes a touch panel. The mobile terminal 100 is a smartphone according to the present example, but may be another type of terminal in accordance with embodiments of the present invention.

The mobile terminal 100 according to an embodiment of the present invention ensures security of information input through the touchscreen 120, in which at least one of an input screen and a touch input signal is secured.

In particular, when the mobile terminal 100 outputs particular screens on the touchscreen 120, it renders, in separate worlds (i.e., the secure and non-secure worlds) screens to be overlaid. Specifically, the mobile terminal 100 renders a secured screen 10 in the secure world and renders a non-secured screen 20 in the non-secure world. The mobile terminal 100 displays the secured screen 10 on the non-secured screen 20 in an overlay form. In one example according to an embodiment of the present invention, the secured screen 10 is a screen on which a virtual input pad is displayed. Here, the input pad may be a keypad having alphanumeric and special keys, or a drawing pad for drawing lines and images.

Hence, a hacking program running in the non-secure world cannot access at least one of information and touch signal displayed on the secured screen 10. It is difficult for a hacking program to predict information input through the touchscreen 120. As a result, embodiments of the present invention may contribute to prevention of theft of information input through the touchscreen 120.

Embodiments of the present invention may be implemented in connection with any application programs requiring a PIN code, such as electronic payment programs, locking programs for terminals, and access locking programs used with respect to specific application programs. Embodiments of the present invention may also be implemented in connection with any application programs requiring alphanumeric input, such as document handling programs and message handling programs. Next, a process for entering a PIN code for electronic payment according to an embodiment of the present invention is described as follows.

A mobile terminal according to an embodiment of the present invention may be any electronic device having a touchscreen and capable of supporting the secure world and non-secure world. For example, the mobile terminal may be a small portable device or electronic appliance, such as a cellular phone, a portable multimedia player, a digital broadcast receiver, a personal digital assistant, music player, such as a Moving Picture Experts Group (MPEG) Audio Layer 3 (MP3) player, a portable game console, a tablet computer, a smartphone, a car navigation aid, a television set, a refrigerator, a washing machine, etc.

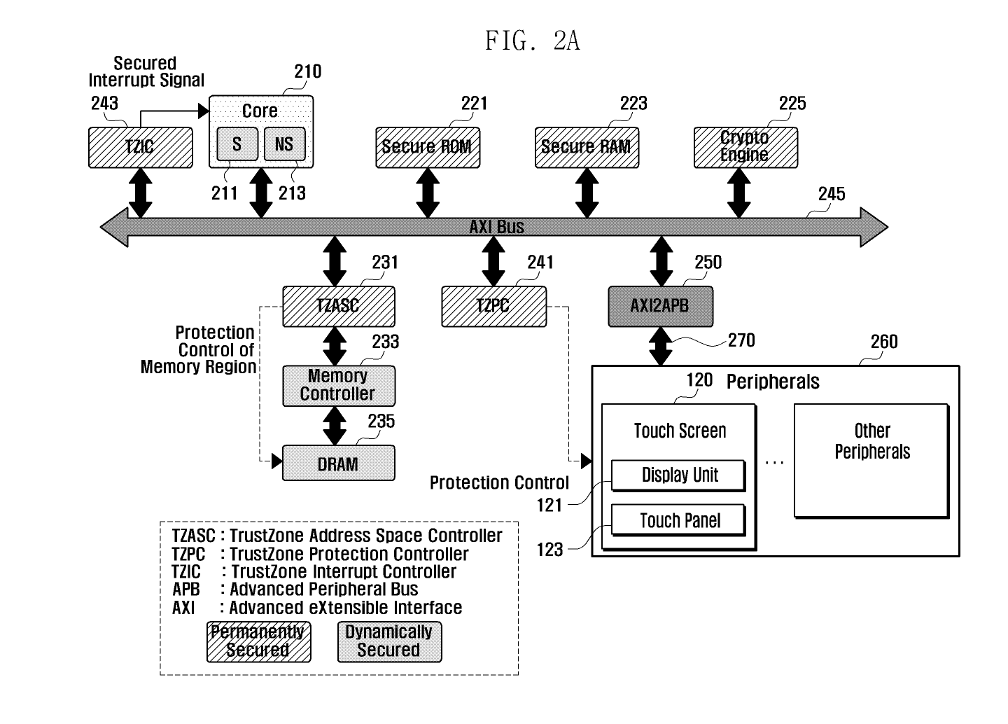

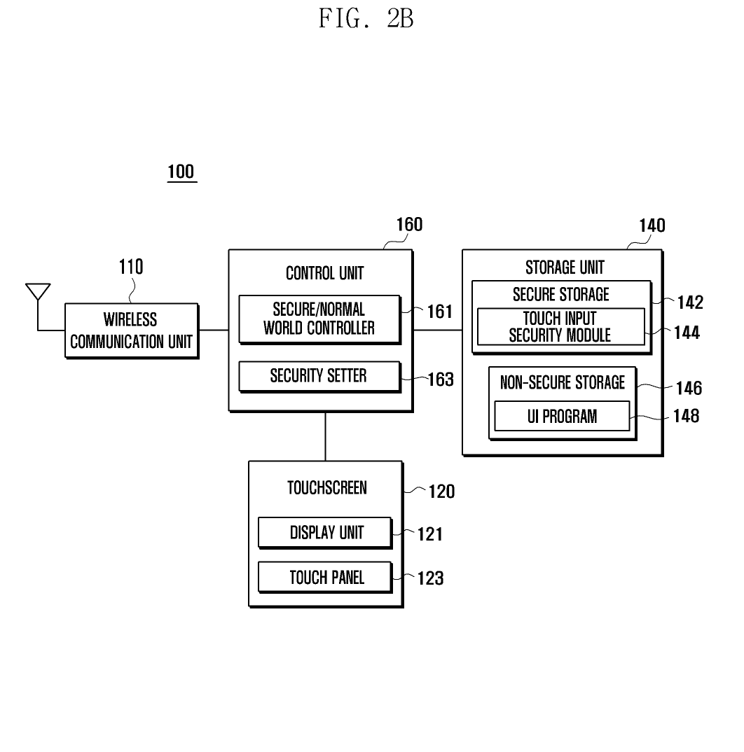

FIG. 2A is a block diagram illustrating a hardware configuration according to an embodiment of the present invention.

Referring to FIG. 2A, the hardware configuration may include a System on a Chip (SoC) based on TrustZone architecture of ARM Holdings and peripheral devices connected to the SoC.

The SoC includes a core processor 210, a secure Read-Only Memory (ROM) 221, a secure Random Access Memory (RAM) 223, a crypto engine 225, a TZASC (TrustZone address space controller) 231, a memory controller 233, a Dynamic RAM (DRAM) 235, a TrustZone Protection Controller (TZPC) 241, and a TrustZone Interrupt Controller (TZIC) 243. The components of the SoC are interconnected for communication through a system bus such as an Advanced eXtensible Interface (AXI) bus 245.

The core processor 210 provides an application execution environment including separate secure and non-secure worlds. To achieve this, the core processor 210 includes a secure core processor 211 and a non-secure core processor 213. Here, the secure core processor 211, which is a virtual processor, provides the secure world, and the non-secure core processor 213, which is also a virtual processor, provides the non-secure world.

The secure ROM 221 and secure RAM 223 are isolated by hardware and software mechanisms. The secure ROM 221 and secure RAM 223 store a secure operating system, and secure application programs and associated secure data.

The crypto engine 225 performs cryptographic tasks based on cryptographic algorithms.

The TZASC 231 controls memory regions including the DRAM 235. The TZASC 231 controls security of a memory region with particular addresses. For example, the TZASC 231 may set the security attribute of a given memory region of the DRAM 235 to “secure”. Later, when the non-secure core processor 213 attempts to access the memory region of the DRAM 235 whose security attribute is set to “secure”, the TZASC 231 rejects the access attempt. The TZASC 231 allows the secure core processor 211 to access the memory region whose security attribute is set to “secure”.

In one example according to an embodiment of the present invention, the DRAM 235 is equipped with a secure overlay frame buffer and a non-secure overlay frame buffer. The secure overlay frame buffer has a security attribute set to “secure” by the TZASC 231 and is accessible in the secure world. A non-secure application program is not allowed to access the secure overlay frame buffer. In the present example according to an embodiment of the present invention, a non-secure program cannot identify the layout or elements of the secured screen that is rendered in the secure overlay frame buffer. Hence, even if information indicating locations of touch inputs is leaked, security of information on the arrangement of elements with respect to the secured screen is assured. A wallpaper displayed behind the secured screen may be rendered in the non-secure overlay frame buffer of the DRAM 235 whose security attribute is not set.

The memory controller 233 performs data movement within the DRAM 235.

TZPC 241 sets security attributes of peripheral units to control access of the core processor 210 to the peripheral units. In particular, the TZPC 241 may set the security attribute of the touchscreen 120 to “secure”. The touchscreen 120 whose security attribute is set to “secure” is inaccessible from the non-secure world. This is described later in relation with an AXI to Advanced Peripheral Bus (APB) (AXI2APB) bridge 250.

The TZIC 243 sets the security attributes of interrupt lines. In particular, the TZIC 243 sets the security attribute of an interrupt line connected to a touch panel 123. For example, the user may enter a touch input on the touch panel 123 to provide desired information while viewing the secured screen output on a display unit 121. When an input is generated on the touch panel 123, the TZIC 243 ensures security of the corresponding interrupt signal. Then, the secured interrupt signal can be processed by the secure core processor 211. Hence, an interrupt signal corresponding to a contact with the touchscreen 120 is security processed by the TZIC 243, and is received by the secure core processor 211 and information carried by the interrupt signal is indentified. In addition, the TZIC 243 controls the source (i.e., the touch panel 123) of a secured interrupt signal to be masked from a non-secure interrupt controller. When an interrupt signal corresponding to a user touch input is generated on the touch panel 123, the non-secure interrupt controller does not deliver the interrupt signal to the non-secure core processor 213. Hence, the non-secure core processor 213 is unaware of information input by the user, and the input information cannot be used by a hacking program.

Most peripheral units are interconnected through an APB. The touchscreen 120 including the display unit 121 and the touch panel 123 are examples of peripheral units.

Communication between the SoC and peripheral units 260 is performed through the AXI2APB bridge 250. The AXI2APB bridge 250 may arbitrate accesses of the SoC components to the peripheral units 260 via an APB 270.

The AXI2APB bridge 250 is aware of the peripheral units 260 whose security attribute is set to “secure”. When an access attempt from the non-secure world is made to a peripheral unit 260 whose security attribute is set to “secure”, the AXI2APB bridge 250 rejects the access attempt. For example, the TZPC 241 may set the security attribute of the touchscreen 120 to “secure”. The non-secure core processor 213 executing a hacking program may place a request for access to the touchscreen 120 on the AXI bus 245. In response to the request for access to the touchscreen 120 from the non-secure core processor 213, the AXI2APB bridge 250 checks the security attribute of the touchscreen 120. When the security attribute of the touchscreen 120 is set to “secure”, the AXI2APB bridge 250 rejects the access request. Hence, the AXI2APB bridge 250 prevents a non-secure program from accessing the touchscreen 120 for stealing information. The AXI2APB bridge 250 may allow only the secure core processor 211 to place a request for information on the touchscreen 120.

FIG. 2B is a block diagram illustrating a mobile terminal according to an embodiment of the present invention.

Referring to FIG. 2B, a mobile terminal 100 includes a wireless communication unit 110, a touchscreen 120, a storage unit 140, and a control unit 160. Although not shown in FIG. 2B, the mobile terminal 100 may further include other elements, such as a key input unit and an audio processing unit.

The wireless communication unit 110 establishes communication channels for voice calls, video calls, and data calls under the control of the control unit 160. In particular, the wireless communication unit 110 establishes a data communication channel to a web server or another mobile terminal and sends touch input information, such as user's personal information, through the data communication channel.

The touchscreen 120 includes a display unit 121 and a touch panel 123. The touchscreen 120 may be configured so that the touch panel 123 covers the display unit 121. The size of the touchscreen 120 may be determined by the size of the touch panel 123. The touchscreen 120 displays application screens in the secure and non-secure worlds, and senses a touch with an object. In particular, the touchscreen 120 displays a Graphical User Interface (GUI) for touch input, and obtains touch input corresponding to touch of a user object and obtains other information through the GUI.

The display unit 121 displays various menus of the mobile terminal 100, information input by the user, and information to be provided to the user. The display unit 121 outputs execution screens of various user functions in the course of utilizing the mobile terminal 100. The display unit 121 may be realized using a device, such as a Liquid Crystal display (LCD) devices or organic light emitting diodes (OLED). The display unit 121 may be placed above or below the touch panel 123. In particular, the display unit 121 supports a display feature wherein a non-secured screen is overlaid with a secured screen, such that the secured screen is rendered in the secure overlay frame buffer, and the non-secured screen is rendered in the non-secure overlay frame buffer. The display unit 121 displays the secured screen on the non-secured screen in an overlay form by merging contents of the secure overlay frame buffer and non-secure overlay frame buffer.

The touch panel 123 is placed at a lower or upper portion of the display unit 121. Sensors included in the touch panel 123 are arranged in a matrix form. The touch panel 123 generates a touch signal corresponding to contact or proximity between an object and the touch panel 123, and sends the touch signal to the control unit 160.

In particular, the security attribute of the touch panel 123 is set to “secure” by the control unit 160. When the security attribute of the touch panel 123 is set to “secure”, the touch panel 123 can only be used in the secure world and cannot be used in the non-secure world. Hence, the touch panel 123 whose security attribute is set to “secure” is protected from non-secure programs such as hacking programs.

In addition, the security attribute of an interrupt line connected to the touch panel 123 is changeable. When the security attribute of the interrupt line connected to the touch panel 123 is set to “secure”, an interrupt signal (i.e., a touch input signal) from the touch panel 123 is sent to the control unit 160 in the secure world. Hence, when the user touches the touch panel 123 with an object to enter information requiring security, such as personal information or passcodes, the touch input is forwarded to the control unit 160 in the secure world. As the control unit 160 operating in the non-secure world is incapable of recognizing such touch input, a non-secure program cannot identify such touch input. Embodiments of the present invention may ensure security of input information via the touch panel 123 and interrupt line, whose security attribute is set to “secure”.

The storage unit 140 stores at least one application program needed to perform secure world functions and non-secure world functions according to embodiments of the present invention, and also stores user data such as messages and application data. The storage unit 140 includes a secure storage 142 and a non-secure storage 146.

The secure storage 142 corresponds to the secure ROM 221 and secure RAM 223 of FIG. 2A. The secure storage 142 is mounted in the mobile terminal 100 such that the secure storage 142 is isolated by hardware and software mechanisms. The secure storage 142 stores an operating system for the secure world and information regarding secure application programs. Access to the secure storage 142 from the control unit 160 operating in the non-secure world is physically prohibited. As the secure storage 142 has a limited capacity by design, the security storage 142 stores a secure application program having a simple function and associated data. In particular, the secure storage 142 further stores a touch input security module 144. The secure storage 142 further stores a monitor program to support transition between the secure world and the non-secure world.

The touch input security module 144 includes a routine for displaying a secured screen above a non-secured screen as an overlay and ensuring security of touch signals. The touch input security module 144 includes a routine for displaying a secured screen containing a virtual input pad. The touch input security module 144 includes a routine for setting the security attribute of peripheral units related to touch input and of the data bus, a routine for displaying a secured input screen by rendering a secured screen in the secure storage 142 and by outputting the secured screen above a non-secured screen as an overlay, and a routine for receiving and processing a secured touch signal. Herein, the secured input screen refers to display of a secured screen above a non-secured screen as an overlay, and the secured screen may have a virtual input pad.

The non-secure storage 146 includes a program region and a data region (not shown).

The program region stores an operating system for booting the mobile terminal 100 and operating individual components thereof in the non-secure world, and non-secure application programs that are downloaded or pre-installed. In particular, the program region may store a User Interface (UI) program 148.

The UI program 148 initiates a secured input mode, and renders a non-secured screen among execution screens of a given application program in the non-secure world. In the secured input mode, security of information input through the touch panel 123 is ensured. According to embodiments of the present invention, a secured input screen is displayed in the secured input mode. The UI program 148 renders a non-overlay screen among application screens as a non-secured screen, and renders a screen that does not contain an input pad among overlay screens as a non-secured screen. The UI program 148 may be contained as a part in an application program requiring PIN code input or contained in an application program requiring alphanumeric input such as a document or message handling program. An application program containing the UI program 148 transitions to, in response to a request for entering specific touch keys mapped with characters or numerals, the secured input mode, and supports rendering in the non-secure world.

Although not intended, the program region may store an unauthorized hacking program. The hacking program executes in the non-secure world.

Hence, various personal information located in the non-secure world may be leaked by the hacking program. However, according to embodiments of the present invention, as the apparatus for securing touch input receives and processes a touch signal in the secure world, embodiments of the present invention can protect information input through the touch panel 123 from an attack made by a hacking program running in the non-secure world.

The data region stores data generated in the course of utilizing the mobile terminal 100. In particular, the data region stores data that is used or generated by the UI program 148 during execution. For example, the data region may buffer or store a Graphical User Interface (GUI) to be displayed during execution of the UI program 148. Accordingly, the data region includes an overlay frame buffer whose security attribute is settable.

The security attribute of the data region itself, as well as portions thereof, are settable. When the security attribute of the data region is set to “secure”, the control unit 160 only accesses the data region in the secure world. Hence, a non-secure program cannot access the data region when the security attribute of the data region is set to “secure”. In particular, a part of the data region used by the touch input security module 144 may be set for security by the control unit 160.

The control unit 160 controls the overall operation of the mobile terminal 100. In particular, the control unit 160 supports the secure world and non-secure world, displays a secured input screen having a secured screen as an overlay, and ensures security of touch signals, thereby preventing theft of information input through the touch panel 123. To prevent the theft of information, the control unit 160 includes a secure/normal world controller 161 and a security setter 163.

The secure/normal world controller 161 includes a virtual secure world controller, a virtual normal world controller, and a security world switcher (not shown). The secure/normal world controller 161 corresponds to the core processor 210 of FIG. 2A. The virtual secure world controller executes a secure program on top of the secure operating system in the secure world.

According to an embodiment of the present invention, the virtual secure world controller executes the touch input security module 144. Hence, the virtual secure world controller controls the display unit 121 to display a secured screen above a non-secured screen as an overlay, and receives and processes secured touch input signals in the secure world.

The virtual normal world controller executes a normal non-secure program on top of the non-secure operating system. In particular, the virtual normal world controller executes the UI program 148 in the non-secure world. Hence, the virtual normal world controller initiates the secured input mode in response to a request for secured input.

The security world switcher executes a monitor program to schedule and control transitions between roles of the virtual secure world controller and the virtual normal world controller in a time sliced fashion. The monitor program is stored in the secure storage 142. When a transition occurs between the secure world and the non-secure world, the monitor program saves the state of the previous world. For world transition, the monitor program may assume a role at least partly in clearing registers, restoring current contexts and saving previous contexts. In particular, the security world switcher transitions to the secure world in response to a secure input request in the non-secure world.

The security setter 163 sets security attributes of the components of the mobile terminal 100. When the security setter 163 sets the security attribute of one component to “secure”, the component is usable only in the secure world. The security setter 163 corresponds to the TZIC 243, TZAC 231, and the TZPC 241 of FIG. 2A. In particular, the security setter 163 sets security attributes of the touch panel 123, the interrupt line connected to the touch panel 123, and a portion of the data region associated with the touch input security module 144.

A method for securing touch input according to an embodiment of the present invention is described as follows.

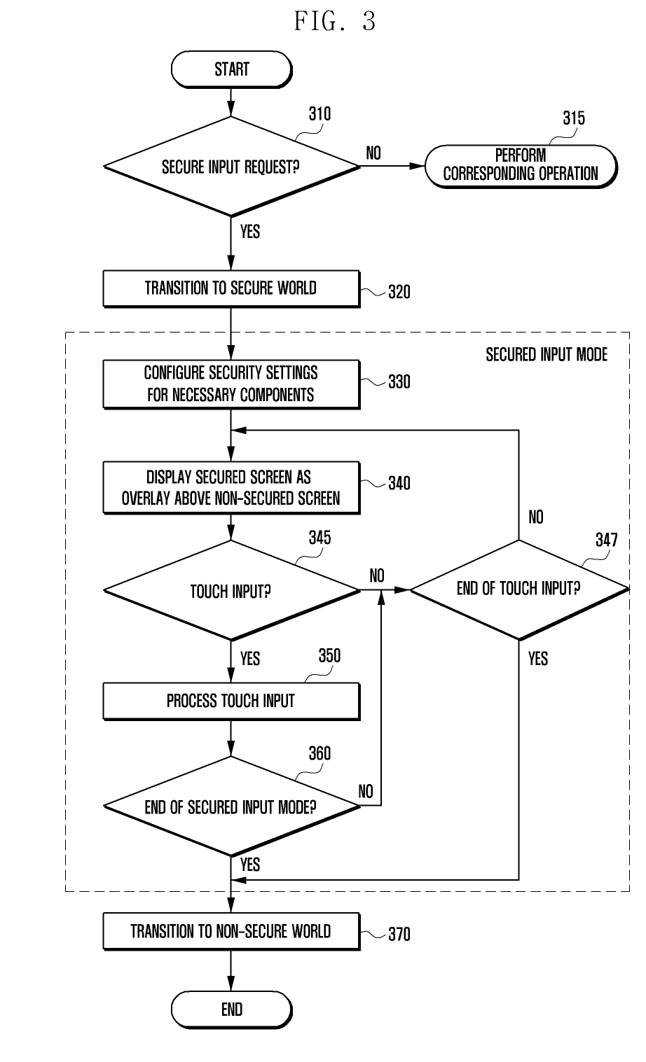

FIG. 3 is a flowchart illustrating a method for secured input through a touch panel according to another embodiment of the present invention.

Referring to FIG. 3, the method begins from the non-secure world. The control unit 160 checks whether a secure input request is received, in step 310. A secure input request involves displaying a secured input screen. When a secure input request is received, the control unit 160 transitions to the secure world, in step 320. When an input other than a secure input request is received, the control unit 160 performs an operation corresponding to the received input, in step 315.

After entering the secure world, the control unit 160 executes the touch input security module 144 stored in the secure storage 142 to thereby perform secured input mode operations. Operations performed in the secured input mode correspond to steps 330 to 360.

The control unit 160 configures security settings for touch input, in step 330. For example, the control unit 160 may set the security attribute of a region of the storage unit 140 and the touchscreen 120 related to touch input to “secure”. The control unit 160 controls the display unit 121 to output a secured input screen by displaying a secured screen above a non-secured screen as an overlay, in step 340. Here, the secured screen is rendered in the secure overlay frame buffer, the non-secured screen is rendered in the non-secure overlay frame buffer, and the secured screen is displayed above the non-secured screen as an overlay to form the secured input screen.

The control unit 160 checks whether a touch input is received within a preset duration, in step 345. Here, the control unit 160 may receive a touch input from the touch panel 123. When a touch input is not received within the preset duration, the control unit 160 checks whether touch input has ended, in step 347. The control unit 160 may determine whether touch input has ended on the basis of expiration of a given time duration or a preset end key entered by the user. Upon a determination that touch input has not ended, the control unit 160 returns to step 340 and outputs the secured input screen. Upon determining that touch input is ended, the control unit 160 transitions back to the non-secure world, in step 370.

When a touch input is received, the control unit 160 processes the touch input in the secure world, in step 350. Here, referring to the layout (i.e., elements) of the secured screen, the control unit 160 identifies the element at which a touch is entered and identifies information entered by the user in the secure world. Thereafter, the control unit 160 checks whether to end the secured input mode, in step 360. Here, the control unit 160 may determine whether to terminate the secured input mode on the basis of a preset number of inputs or expiration of a given duration. When the secured input mode is ended, the control unit 160 transitions back to the non-secure world, in step 370. When the secured input mode has not ended, the control unit 160 returns to step 347 and checks whether touch input has ended.

After transitioning back to the non-secure world, the procedure for secured touch input ends. As described above, an embodiment of the present invention supports secured input using the procedure of FIG. 3.

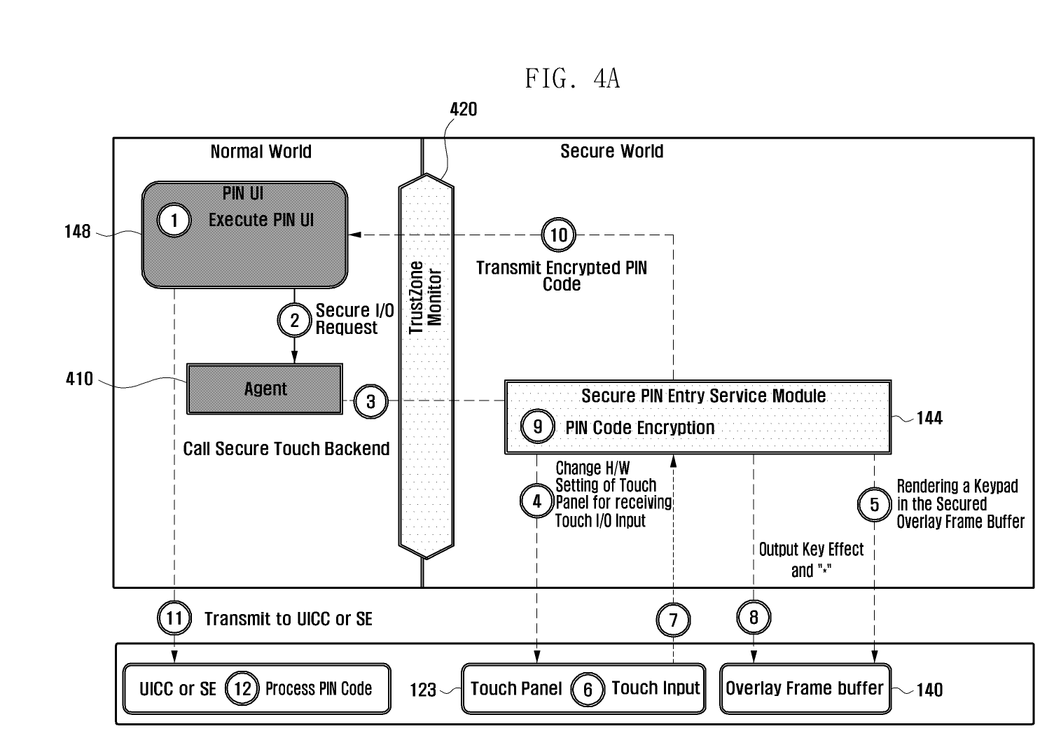

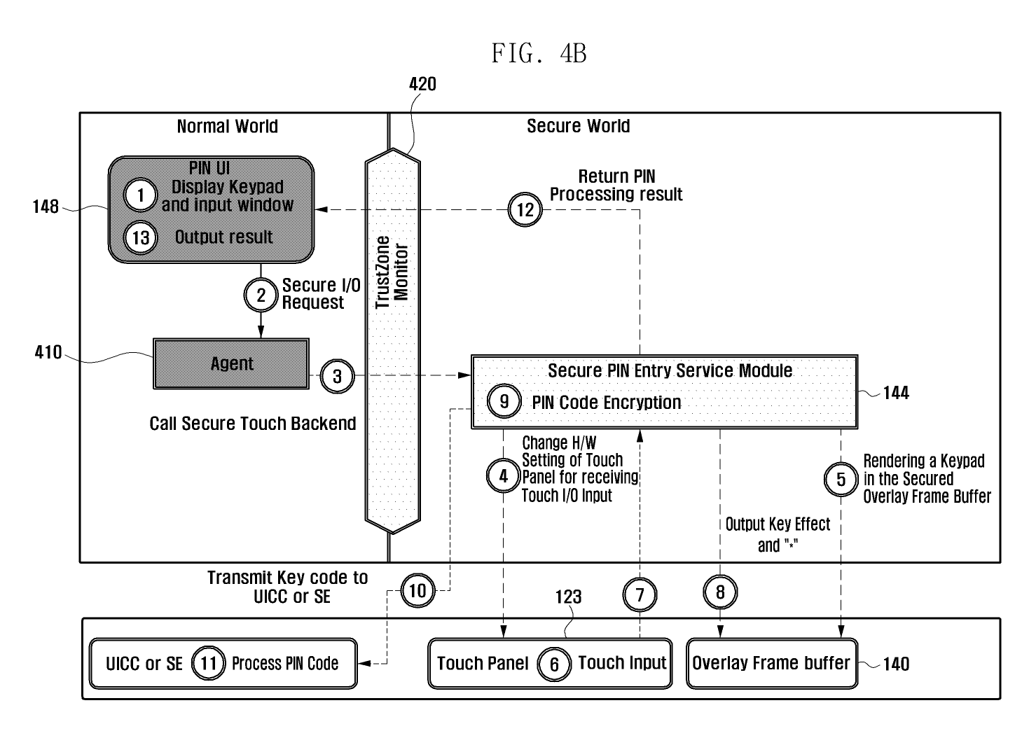

A method for secured touch input may be implemented using a software architecture shown in FIG. 4A or 4B.

FIG. 4A is a diagram illustrating a software architecture supporting the method for secured touch input in FIG. 3 according to an embodiment of the present invention. In the present example, the software architecture is assumed to support electronic payment in a smartphone employing TrustZone Technology of ARM Holdings, but other technologies may be used in accordance with embodiments of the present invention.

Referring to FIG. 4A, the software architecture includes a PIN UI program 148, an agent 410, and a PIN code input security module 144. A TrustZone monitor 420 is present between the secure world and the non-secure (normal) world. The PIN UI program 148 is stored in the non-secure storage 146, and receives a PIN code input request for electronic payment. The agent 410 operates in the non-secure world and invokes a specific program in the secure world. The PIN code input security module 144 is stored in the secure storage 142, and displays a virtual keypad and processes an input PIN code.

Interactions between components of the software architecture according to an embodiment of the present invention is described as follows.

The PIN UI program 148 is executed, at step (1). In response to user input, the PIN UI program 148 sends a secure I/O request to the agent 410, at step (2). For example, when the user enters a button for electronic payment after finishing online shopping, the PIN UI program 148 sends a secure I/O request to the agent 410. In return, the agent 410 invokes the secure touch backend, in step (3), thereby initiating the PIN code input security module 144 in the secure world. More specifically, the agent 410 requests a transition from the non-secure world to the secure world by invoking a Secure Monitor Call (SMC). Upon SMC invocation, a transition occurs from the non-secure world to the secure world, and the TrustZone monitor 420 is executed. The TrustZone monitor 420 stores register contents of the non-secure core processor 213 in a given stack. This storage enables restoration of non-secure world states after transitioning back to the non-secure world. After storing the register contents of the non-secure core processor 213, the TrustZone monitor 420 supports execution of the PIN code input security module 144.

In the secure world, a secured keypad is displayed, and a PIN code is received and processed, in steps (4) to (10). The PIN code input security module 144 sets the security attribute (changes hardware settings) of the touch panel 123 to “secure” so as to receive touch input in the secure world, in step (4). Here, the PIN code input security module 144 drives the TZPC 241, TZIC 243, and TZASC 231 to change security attributes of the touch panel 123, the interrupt line connected to the touch panel 123, and the overlay frame buffer. The PIN code input security module 144 controls an operation to render a keypad screen for PIN code input in the secure overlay frame buffer, not in the non-secure overlay frame buffer, in step (5).

After output of the keypad screen, the user touches keys displayed on the touchscreen 120 with a touch object to enter a PIN code, in step (6). The PIN code input security module 144 receives secured touch input, in step (7), and outputs a character “*” as an indication of key input from the user, in step (8). The PIN code input security module 144 encrypts the touch input, (i.e., a PIN code, in step (9).

Steps (6) to (9) are repeated until a preset number of digits forming a PIN code are input. Step (9) is performed after a preset number of digits are input. Step (8) may be performed in the non-secure world.

After PIN code input, the PIN code input security module 144 sends the encrypted PIN code to the PIN UI program 148, in step (10). The PIN UI program 148 forwards the encrypted PIN code to a touch input processing device such as a Universal Integrated Circuit Card (UICC) or Secure Element (SE), in step (11). Here, the SE is a combination of a Subscriber Identity Module (SIM) containing subscriber information and a UICC, and is also referred to as a Universal Subscriber Identity Module (USIM). The UICC or the SE processes and validates the PIN code, in step (12). Here, the encrypted PIN code may be decrypted and compared with a pre-stored passcode.

According to another embodiment of the present invention, after the PIN code is input, an encrypted PIN code may be sent directly to the UICC or the SE in the secure world (bypassing the non-secure world).

A method for transmitting an encrypted PIN code directly to the UICC or the SE is described as follows with reference to FIG. 4B. As steps (1) to (9) in FIG. 4B are identical respectively to steps (1) to (9) in FIG. 4A, a description thereof is omitted for conciseness.

Referring to FIG. 4B, after the PIN code is input, the PIN code input security module 144 sends the encrypted PIN code directly to the UICC or SE (i.e., not via the PIN UI program 148), in step (10). In this case, PIN code transmission is performed in the secure world, providing a higher level of security.

The UICC or SE processes and validates the PIN code, in step (11). When the UICC or SE notifies the PIN code input security module 144 of the PIN processing result, the PIN code input security module 144 forwards the PIN processing result to the PIN UI program 148, in step (12). Finally, the PIN UI program 148 causes the PIN processing result to be displayed on the display unit 121, in step (13). Hence, the user is informed of the result of PIN code input through the PIN UI program 148.

As described above, embodiments of the present invention can be applied to an electronic payment application based on a given software architecture.

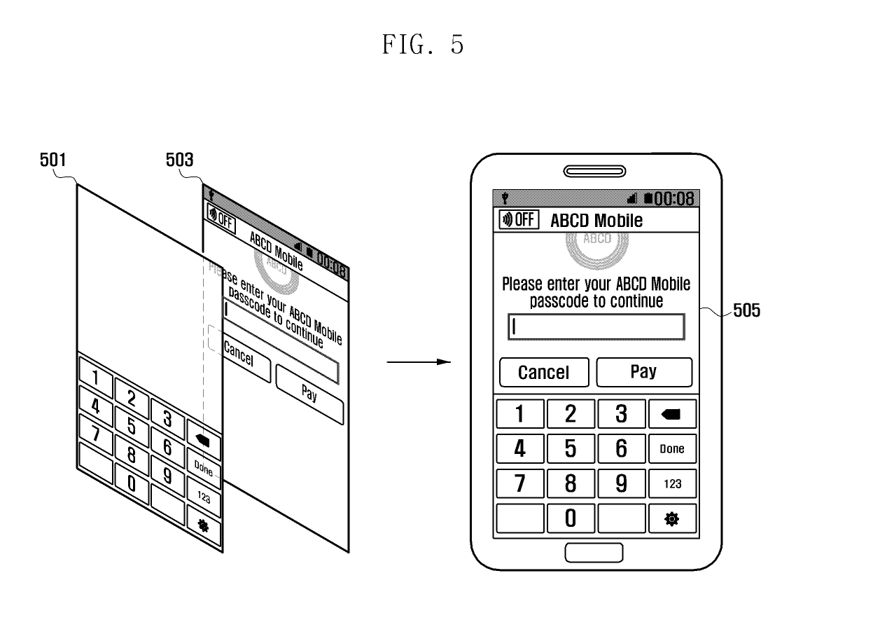

FIG. 5 is a diagram illustrating a touch input screen that depicts implemented by a mobile terminal on the basis of the software architecture of FIG. 4A or 4B according to an embodiment of the present invention.

Referring to FIG. 5, the mobile terminal 100 of FIG. 1, which employs the software architecture of FIG. 4A or 4B, outputs a secured input screen 505 by displaying a secured keypad screen 501 above an execution screen 503 of the PIN UI program 148 as an overlay. In addition, the mobile terminal 100 sets the security attribute of the interrupt line connected to the touch panel 123 to “secure”.

As described above, according to an embodiment of the present invention, a secured keypad screen 501 is displayed above an application screen 503 as an overlay to thereby form a secured input screen 505. Hence, security of touch input is ensured and PIN code information input through the touch panel 123 can be protected from theft. As a result, embodiments of the present invention can preserve existing PIN code input schemes while protecting safety of input information from a hacking program.

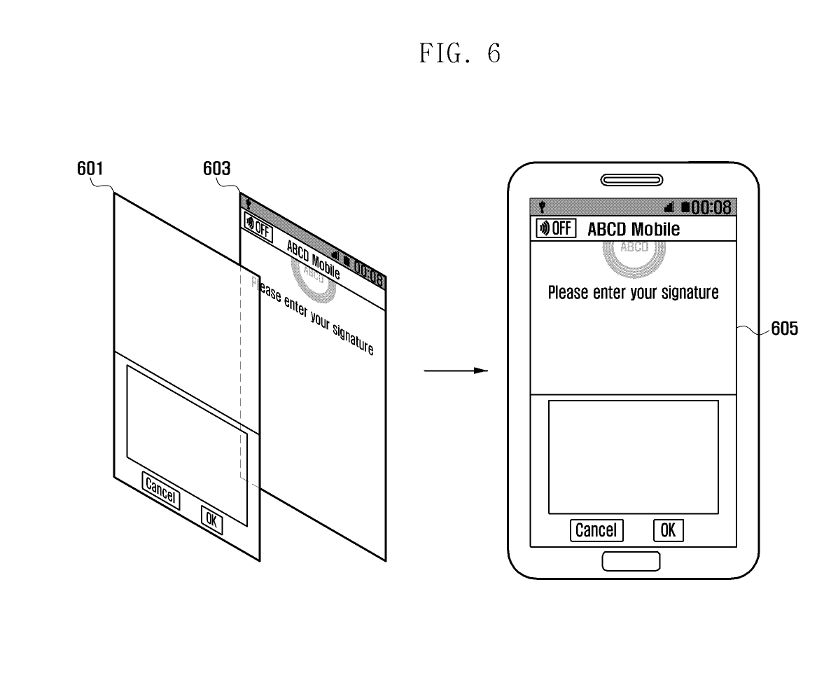

In another example according to an embodiment of the present invention, an electronic payment application requires a signature instead of a PIN code. In such a case, as shown in FIG. 6, the mobile terminal 100 uses a secured drawing-pad screen 603 instead of the secured keypad screen 501.

FIG. 6 is a diagram illustrating a touch input screen using a drawing-pad according to an embodiment of the present invention.

Referring to FIG. 6, the mobile terminal 100 employing the software architecture of FIG. 4A or 4B outputs a secured input screen 605 by displaying a secured drawing-pad screen 601 above an execution screen 603 of the PIN UI program 148 as an overlay. The mobile terminal 100 may render the secured drawing-pad screen 601 in the secure world. When rendering the secured drawing-pad screen 601 in the secure world, the mobile terminal 100 protects security of a signature (touch signal) input through the touch panel 123.

As described above, according to embodiments of the present invention, different virtual input pads are used in secured screens for various types of application programs. For example, the secured input mode can be supported by electronic payment application programs, application programs requiring PIN code input such as a terminal locking program and access blocking program against a given application, and application programs requiring alphanumeric input such as a document writing program and a message composition program.

As described above, in a method and apparatus for securing touch input according to an embodiment of the present invention, a secured input screen is formed by displaying a secured screen as an overlay on a non-secured screen, and security of touch input is ensured. Thereby, theft of information input through the touch panel 123 by a hacking program is prevented.

Embodiments of the present invention may be applied, not only to application programs requiring PIN code input, but also to other application programs requiring alphanumeric input. When the user enters characters or digits on the touch panel, embodiments of the present invention can ensure security of touch signals generated by the touch panel and ensure security of input pad layout information. Hence, embodiments of the present invention can prevent theft of information input through the touch panel.

In a feature of embodiments of the present invention, when sensitive data is to be entered, the security method and apparatus can output a secured screen on top of a normal non-secured screen and secure touch input so as to prevent theft of information that is input through the touch panel. Hence, personal information entered through the touch panel can be protected from a hacking program.

Although embodiments of the present invention have been described in detail hereinabove, it should be understood that many variations and modifications of the basic inventive concept described herein will still fall within the spirit and scope of the present invention as defined in the appended claims.

What is claimed is:

1. A method for securing touch input, comprising:
rendering a first screen in a secure world;
rendering a second screen in a non-secure world; and
outputting a secured input screen by displaying the first screen as an overlay above the second screen.

2. The method of claim 1, further comprising:
receiving a touch input; and
indentifying input information with reference to the touch input and the first screen.

3. The method of claim 2, wherein the receipt of the touch input is performed in the secure world.

4. The method of claim 2, further comprising limiting, to the secure world, access to at least one of the first screen and the touch input.

5. The method of claim 1, wherein the first screen contains a virtual input pad at a portion thereof.

6. The method of claim 5, wherein the virtual input pad is one of a keypad and a drawing pad.

7. The method of claim 1, wherein outputting the secured input screen comprises displaying the first screen as a topmost overlay.

8. The method of claim 1, wherein the secured input screen is output in response to reception of a secure input request.

9. An apparatus for securing touch input, comprising:
a secure overlay frame buffer for rendering a first screen;
a non-secure overlay frame buffer for rendering a second screen;
a display unit for outputting a secured input screen; and
a control unit for controlling the display unit to display the first screen as an overlay above the second screen so as to produce the secured input screen.

10. The apparatus of claim 9, wherein the control unit sets a security attribute of the secure overlay frame buffer.

11. The apparatus of claim 9, further comprising a touch panel receiving a touch input,
wherein the control unit sets a security attribute of the touch panel.

12. The apparatus of claim 11, further comprising an interrupt line that is connected to the touch panel,
wherein the control unit and delivers the touch input to the control unit and sets a security attribute of the interrupt line.

13. The apparatus of claim 11, wherein the control unit sets, in response to reception of a secure input request, the security attribute of the secure overlay frame buffer and touch panel.

14. The apparatus of claim 11, wherein the control unit indentifies security information input through the touch panel with reference to the first screen and the touch input.

15. The apparatus of claim 14, wherein the control unit indentifies the security information in a secure world.

16. The apparatus of claim 15, wherein the control unit encrypts the security information in the secure world, and forwards the encrypted security information to at least one of a Universal Integrated Chip Card (UICC) and a Secure Element (SE) in the secure world or a non-secure world.

17. The apparatus of claim 16, wherein the at least one of the UICC and the SE decrypts the encrypted security information and determines whether the decrypted security information matches a preset passcode.

18. The apparatus of claim 9, wherein the first screen contains a virtual input pad at a portion thereof.

19. The apparatus of claim 18, wherein the virtual input pad is one of a keypad and a drawing pad.

20. The apparatus of claim 9, wherein the control unit controls the display unit to display the first screen as a topmost overlay on the secured input screen.

21. The apparatus of claim 9, wherein the control unit comprises:
a non-secure core processor;
a secure core processor;
an address space controller for configuring a portion of a storage unit as a secure region, preventing the non-secure core processor from accessing the secure region of the storage unit, and supporting the secure core processor in accessing the secure region of the storage unit;
a protection controller for setting security attributes of peripheral units;
a bridge for preventing the non-secure core processor from accessing peripheral units whose security attributes are set as secured, and supporting the secure core processor in access to peripheral units whose security attributes are set as secured; and
an interrupt controller setting security attributes of interrupt lines, preventing the non-secure core processor from accessing interrupt lines whose security attributes are set as secured, and supporting the secure core processor in access to interrupt lines whose security attributes are set as secured.

22. The apparatus of claim 21, wherein the protection controller sets a security attribute of a touchscreen having a display unit and a touch panel.

23. The apparatus of claim 22, wherein the interrupt controller sets security attributes of interrupt lines connected with the touchscreen.

24. An apparatus for securing touch input, comprising:
a touchscreen having a touch panel and a display unit;
a secure storage for storing a Personal Identification Number (PIN) code input security module;
a non-secure storage for storing a PIN User Interface (UI) program and an agent; and
a control unit controlling the touchscreen, secure storage, and non-secure storage,
wherein the PIN UI program sends a secure Input/Output (I/O) request to the agent in response to user input, the agent initiates the PIN code input security module in response to the secure I/O request, and the PIN code input security module sets a security attribute of the touch panel as secured, directs a secure overlay frame buffer to render a keypad screen, receives touch input from the touch panel whose security attribute is set as secured, and forwards the received touch input to the PIN UI program or a touch input processing device.

25. The apparatus of claim 24, wherein the touch input processing device is one of a Universal Integrated Circuit Card (UICC) and a Secure Element (SE).

26. The apparatus of claim 24, wherein the PIN code input security module outputs symbols corresponding to the touch input to the secure overlay frame buffer.

27. The apparatus of claim 24, wherein the PIN code input security module encrypts the received touch input and sends the encrypted touch input to the PIN UI program or to the touch input processing device.
